(19) United States
(12) Patent Application Publication
(10) Pub. No.: US 2025/0337542 A1
(43) Pub. Date: Oct. 30, 2025

(54) DEVICES, SYSTEMS, AND METHODS INCLUDING RADIO FREQUENCY COMMUNICATION WITH BITWISE REPORTING PROTOCOL

(71) Applicant: Aclara Technologies LLC, St. Louis, MO (US)

(72) Inventor: David Donald Haynes, St. Peters, MO (US)

(21) Appl. No.: 19/188,740

(22) Filed: Apr. 24, 2025

Related U.S. Application Data
(60) Provisional application No. 63/638,670, filed on Apr. 25, 2024.

(51) Int. Cl. H04L 5/00

(52) U.S. Cl. CPC H04L 5/0048; H04L 5/0053

(57) ABSTRACT

A device may include a memory, an electronic processor, and a communication interface configured to wirelessly communicate with a second communication device. The electronic processor is configured to control the communication interface to continuously transmit a first transmission symbol from a plurality of transmission symbols until either a first reception symbol from a plurality of reception symbols is received or an end of message is reached, control the communication interface to continuously transmit a second transmission symbol from the plurality of transmission symbols until either a second reception symbol from the plurality of reception symbols is received or the end of message is reached, control the communication interface to continuously transmit a third transmission symbol from the plurality of transmission symbols until either a third reception symbol from the plurality of reception symbols is received or the end of message is reached.

### CROSS-REFERENCE TO RELATED APPLICATION

This application claims the benefit of, and priority to, U.S. Provisional Application No. 63/638,670, filed on Apr. 25, 2024, the entire contents of which are incorporated herein in their entirety.

### FIELD

The present disclosure relates generally to wireless communication systems. More specifically, the present disclosure relates to radio frequency (RF) communication with a bitwise reporting protocol.

### BACKGROUND

Network users want both high speed and high accuracy. Conventional RF protocols discover only after transmitting a symbol whether the symbol transmission was a success. In order to gain success, a slow baud rate is chosen that causes the transmitted symbol to be repeated unnecessarily. Frequency Modulation (FM) has the characteristic in which a particular tone is used to represent a symbol. The tone is held for many cycles.

The network will be operated at a baud rate that gives the network (presumably) 98% reliability. However, many of the symbol transmissions are unnecessarily long, and in other cases, where there is a bit error, the tone is ostensibly not maintained long enough.

### SUMMARY

The use of spectrum over the air is usually regulated by a government entity in the country in which the transmitter operates. Higher speeds tend to require wider bandwidths. The bandwidth is a band of frequencies around the center frequency which is licensed or awarded by the regulating entity (e.g., FCC, ITU, etc.) The present application remains within any restrictions imposed by the regulating entity and does not violate the allowed bandwidth. The speed of the transmission must otherwise be throttled to keep the “emissions” within the allowed band.

In order to increase speed and accuracy, the present application describes a way to “right size” the baud rate by means of bitwise acknowledgement. Specifically, the present application is regarding full duplex communication with respect to Frequency Modulation (FM), and in each direction a symbol constellation of three or more symbols.

However, the present application is not limited to FM. The symbols described in the present application may also be represented in other modulation schemes in place of, or in addition to, FM. Specifically, the other modulation schemes may include Gaussian Frequency Shift Keying (GFSK) modulation, Amplitude Modulation (AM), Pulse Position Modulation (PPM), and/or any other suitable modulation scheme.

In some aspects, the techniques described herein relate to a communication device including: a communication interface including a radio frequency (RF) transceiver, the communication interface configured to wirelessly communicate with a second communication device; a memory; and an electronic processor communicatively connected to the memory and the communication interface, the electronic processor is configured to control the communication interface to continuously transmit a first transmission symbol from a plurality of transmission symbols until either a first reception symbol from a plurality of reception symbols is received or an end of message is reached, responsive to receiving the first reception symbol, control the communication interface to continuously transmit a second transmission symbol from the plurality of transmission symbols until either a second reception symbol from the plurality of reception symbols is received or the end of message is reached, responsive to receiving the second reception symbol, control the communication interface to continuously transmit a third transmission symbol from the plurality of transmission symbols until either a third reception symbol from the plurality of reception symbols is received or the end of message is reached, and responsive to reaching the end of message, control the communication interface to stop transmitting to the second communication device.

In some aspects, the techniques described herein relate to a communication method including: controlling, with an electronic processor, a communication interface to continuously transmit a first transmission symbol from a plurality of transmission symbols to a second communication device until either a first reception symbol from a plurality of reception symbols is received or an end of message is reached; responsive to receiving the first reception symbol, controlling, with the electronic processor, the communication interface to continuously transmit a second transmission symbol from the plurality of transmission symbols until either a second reception symbol from the plurality of reception symbols is received or the end of message is reached; responsive to receiving the second reception symbol, controlling, with the electronic processor, the communication interface to continuously transmit a third transmission symbol from the plurality of transmission symbols until either a third reception symbol from the plurality of reception symbols is received or the end of message is reached; and responsive to reaching the end of message, controlling, with the electronic processor, the communication interface to stop transmitting to the second communication device.

In some aspects, the techniques described herein relate to a communication device including: a communication interface including a radio frequency (RF) transceiver, the communication interface configured to wirelessly communicate with a second communication device; a memory; and an electronic processor communicatively connected to the memory and the communication interface, the electronic processor is configured to control the communication interface to detect a plurality of transmission symbols, responsive to detecting a first transmission symbol of the plurality of transmission symbols, control the communication interface to transmit a first reception symbol from a plurality of reception symbols, responsive to detecting a second transmission symbol of the plurality of transmission symbols, control the communication interface to transmit a second reception symbol from the plurality of reception symbols, responsive to detecting a third transmission symbol of the plurality of transmission symbols, control the communication interface to transmit a third reception symbol from the plurality of reception symbols, determine whether a symbol timeout period has elapsed since a last transmission symbol of the plurality of transmission symbols was detected, and responsive to determining that the symbol timeout period has elapsed, store an end of message bit in the memory.

In some aspects, the techniques described herein relate to a communication method including: controlling, with an electronic processor, a communication interface to detect a plurality of transmission symbols; responsive to detecting a first transmission symbol of the plurality of transmission symbols, controlling the communication interface to transmit a first reception symbol from a plurality of reception symbols; responsive to detecting a second transmission symbol of the plurality of transmission symbols, controlling, with the electronic processor, the communication interface to transmit a second reception symbol from the plurality of reception symbols; responsive to detecting a third transmission symbol of the plurality of transmission symbols, controlling, with the electronic processor, the communication interface to transmit a third reception symbol from the plurality of reception symbols; determining, with the electronic processor, whether a symbol timeout period has elapsed since a last transmission symbol of the plurality of transmission symbols was detected, and responsive to determining that the symbol timeout period has elapsed, store an end of message bit in a memory.

### BRIEF DESCRIPTION OF THE DRAWINGS

FIG. 1 is a block diagram illustrating a wireless communication system, according various embodiments of the present disclosure.

FIG. 2 is a diagram illustrating an example of bitwise reporting in the wireless communication system of FIG. 1, according to various embodiments of the present disclosure.

FIG. 3 is a flowchart illustrating a state machine of the communication device in the wireless communication system of FIG. 1, according to various embodiments of the present disclosure.

FIG. 4 is a flowchart illustrating a state machine of the second communication device in the wireless communication system of FIG. 1, according to various embodiments of the present disclosure.

FIG. 5 is a diagram illustrating a first example of transmission and reception tones of the communication device and the second communication device in the wireless communication system of FIG. 1, according to various embodiments of the present disclosure.

FIG. 6 is a diagram illustrating a second example of transmission and reception tones of the communication device and the second communication device in the wireless communication system of FIG. 1, according to various embodiments of the present disclosure.

FIG. 7 is a diagram illustrating a third example of transmission and reception tones of the communication device and the second communication device in the wireless communication system of FIG. 1, according to various embodiments of the present disclosure.

FIG. 8 is a table illustrating communication rates of the wireless communication system of FIG. 1, according to various embodiments of the present disclosure.

FIG. 9 is a flowchart illustrating a method for operating a communication device with a bitwise reporting protocol, according to various embodiments of the present disclosure.

FIG. 10 is a flowchart illustrating a second method for operating a communication device with a bitwise reporting protocol, according to various embodiments of the present disclosure.

FIG. 11 is a block diagram illustrating an example of a first communication device of the wireless communication system of FIG. 1, according various embodiments of the present disclosure.

FIG. 12 is a block diagram illustrating an example of a second communication device of the wireless communication system of FIG. 1, according various embodiments of the present disclosure.

### DETAILED DESCRIPTION OF EXEMPLARY EMBODIMENTS

Before any embodiments of the present disclosure are explained in detail, it is to be understood that the present disclosure is not limited in its application to the details of construction and the arrangement of components set forth in the following description or illustrated in the following drawings. The present disclosure is capable of other embodiments and of being practiced or of being carried out in various ways.

In order to increase speed and accuracy, the present application describes a way to “right size” the baud rate by means of bitwise acknowledgement. Specifically, the present application is regarding full duplex communication with respect to Frequency Modulation (FM), and in each direction a symbol constellation of three or more symbols.

However, the present application is not limited to FM. The symbols described in the present application may also be represented in other modulation schemes in place of, or in addition to, FM. Specifically, the other modulation schemes may include Gaussian Frequency Shift Keying (GFSK) modulation, Amplitude Modulation (AM), Pulse Position Modulation (PPM), and/or any other suitable modulation scheme.

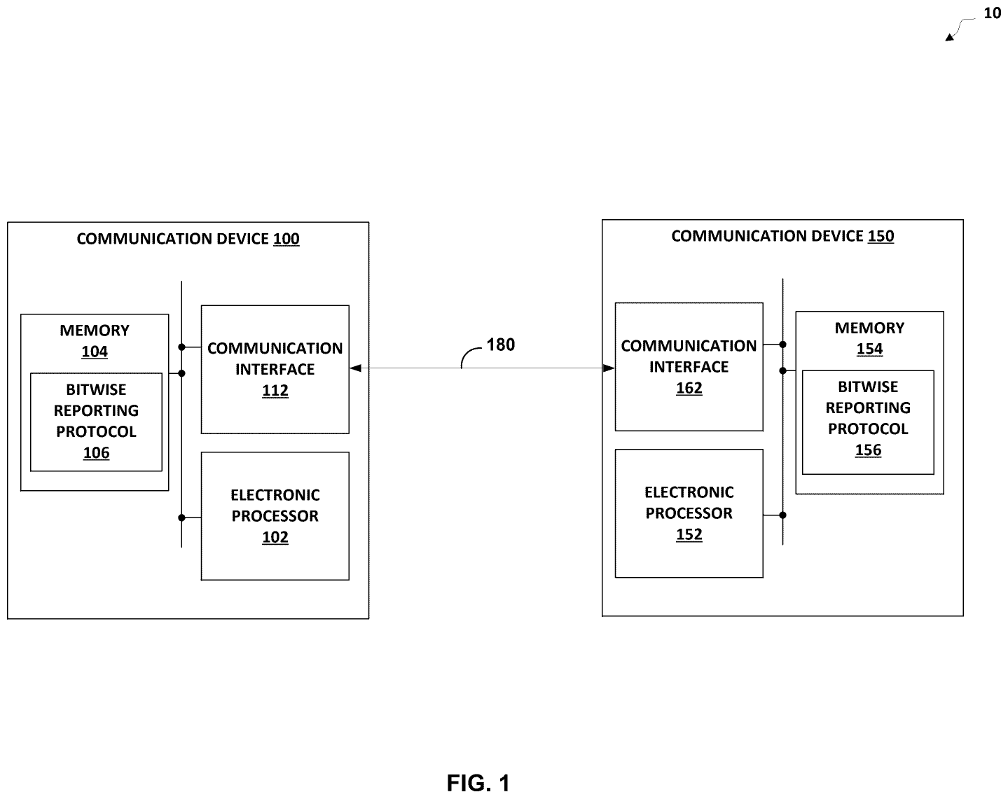

FIG. 1 is a block diagram illustrating a wireless communication system 10, according various embodiments of the present disclosure. In the example of FIG. 1, the wireless communication system includes a communication device 100 and a communication device 150 with a wireless communication link 180.

It should be understood that, in some embodiments, there may be more than the two communication devices 100 and 150 in configurations different from that illustrated in FIG. 1. The functionality described herein may be extended to any number of transceivers providing any number of wireless networks that share spectrum with each other.

In the example of FIG. 1, the communication device 100 includes an electronic processor 102 (for example, a microprocessor or another suitable processing device), a memory 104 (for example, a non-transitory computer-readable storage medium), and a communication interface 112 (e.g., radio frequency (RF) transceiver). It should be understood that, in some embodiments, the communication device 100 may include fewer or additional components in configurations different from that illustrated in FIG. 1. Also, the communication device 100 may perform additional functionality than the functionality described herein. In addition, the functionality of the communication device 100 may be incorporated into other communication devices. As illustrated in FIG. 1, the electronic processor 102, the memory 104, and the communication interface 112 are electrically coupled by one or more control or data buses enabling communication between the components.

The memory 104 may include a program storage area (for example, read only memory (ROM)) and a data storage area (for example, random access memory (RAM), and other non-transitory, machine-readable medium). In some examples, the program storage area may store the instructions regarding a bitwise reporting protocol 106. In some examples, the data storage area stores messages to be sent to the second communication device 150 and/or messages that are received from the second communication device 150.

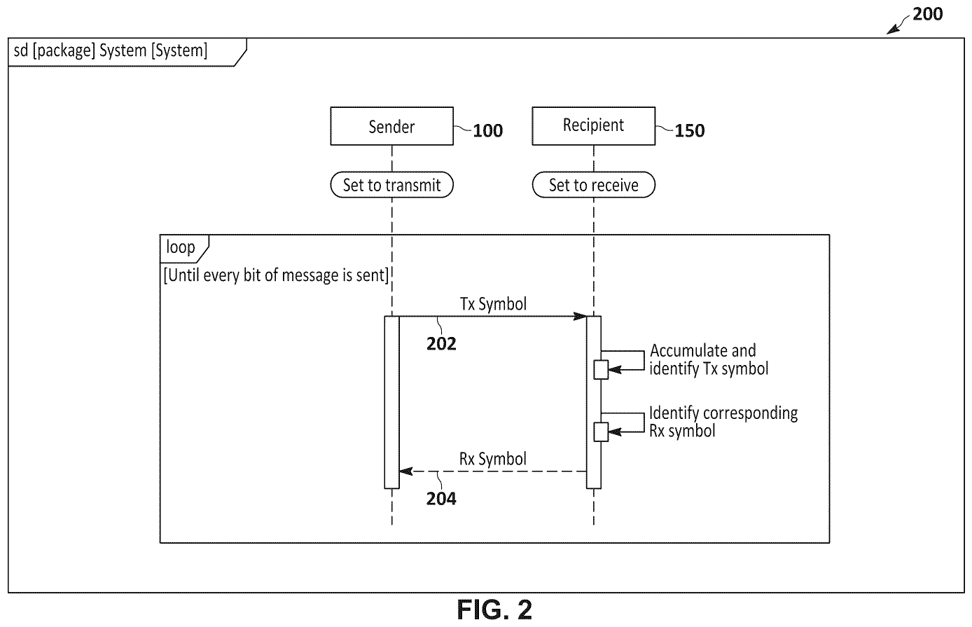

The electronic processor 102 executes machine-readable instructions stored in the memory 104. For example, the electronic processor 102 may execute the bitwise reporting protocol 106 stored in the memory 104 to perform some or all of the functionality described in FIGS. 2-7.

The communication interface 112 receives data from and provides data to devices external to the communication device 100, such as the second communication device 150. For example, the communication interface 112 may include a wireless radio frequency (RF) transceiver with a power amplifier and phase locked loop (PLL). Although the bitwise reporting protocol 106 is described with the communication interface 112 with a RF transceiver, the bitwise reporting may be applied to other types of communication interfaces.

In the example of FIG. 1, the second communication device 150 includes an electronic processor 152 (for example, a microprocessor or another suitable processing device), a memory 154 (for example, a non-transitory computer-readable storage medium), and a communication interface 162. It should be understood that, in some embodiments, the second communication device 150 may include fewer or additional components in configurations different from that illustrated in FIG. 1. Also the second communication device 150 may perform additional functionality than the functionality described herein. In addition, the functionality of the second communication device 150 may be incorporated into other communication devices. As illustrated in FIG. 1, the electronic processor 152, the memory 154, and the communication interface 162 are electrically coupled by one or more control or data buses enabling communication between the components.

The memory 154 may include a program storage area (for example, read only memory (ROM)) and a data storage area (for example, random access memory (RAM), and other non-transitory, machine-readable medium). In some examples, the program storage area may store the instructions regarding a bitwise reporting protocol 156. In some examples, the data storage area stores messages to be sent to the communication device 100 and/or messages that are received from the communication device 100.

The electronic processor 152 executes machine-readable instructions stored in the memory 154. For example, the electronic processor 152 may execute the bitwise reporting protocol 156 stored in the memory 154 to perform some or all of the functionality described in FIGS. 2-7.

The communication interface 162 receives data from and provides data to devices external to the second communication device 150, such as the communication device 100. For example, the communication interface 112 may include a wireless radio frequency (RF) transceiver with a power amplifier and phase locked loop (PLL).

The bitwise reporting protocol 106/156 is regarding full duplex communication, and in each direction a symbol constellation of three or more symbols. The three or more symbols include “1”, “2”, and “3”, where symbol “1” is a zero bit, symbol “2” is a one bit, and symbol “3” is a repeat of the previous symbol message.

Additional symbols may be used beyond those described above. Extensions may include “00”, “01”, “10”, “11”, etc. Larger symbols sets are able to communicate data at higher bit rates. With the minimal set supported, it is possible to add one such extension (such as “00”) without adding the full complement of corresponding symbols (“01”, “10”, and “11”).

Additionally or alternatively, in some examples, a “symbol boundary” may be added to reliably indicate the beginning and end of the message. For example, the three or more symbols may include “1”, “2”, “3”, and “4”, where symbol “1” is a zero bit, symbol “2” is a one bit, symbol “3” is a repeat of the previous symbol message, and symbol “4” is a symbol boundary. The symbol boundary improves reliability by ensuring that no bits are lost.

Moreover, the technique of the present disclosure does not require a high signal strength in order to operate (and maintain message synchronization.) The communication device 100 is expected to keep transmitting its signal until acknowledged by the second communication device 150. The second communication device 150 may be one that, rather than maintaining a synchronous lock with a continuous tone, is a transceiver that accumulates a signal over time. Only after receiving some number of sinewaves at the symbol frequency does the accumulating transceiver recover enough signal to recognize the signal and acknowledge it to the communication device 100.

Whenever the airwaves are shared by multiple devices, some prior arrangement must be made between the communication device 100 and the second communication device 150 in order to coordinate the communication. The bitwise reporting protocol is primarily intended for unicast addressing, but multi-cast operation can be supported as well. The system must have the means to support a chorus of recipients echoing their bitwise acknowledgement signals.

In some examples, the system 10 may be a TDMA system. In a TDMA system it is possible to set up bearers and make arrangements via a schedule so that two or more devices are able to simultaneously transmit at their respective transmit frequencies and communicate with each other.

In other examples, the system 10 may be an Aloha type system. In an Aloha type system, the communication device 100 would have to transmit its message at its transmit frequency, with the expectation that the second communication device 150 is always listening at that frequency. The communication device 100 can address its target by sending a MAC address (and perhaps an authentication code) as a preamble. Then, after arriving at the data payload portion, switch to the bitwise reporting mode. The preamble would operate at the (slow) default fixed data rate. Bitwise reporting would operate at its own controlled data rate.

FIG. 2 is a diagram illustrating an example 200 of bitwise reporting in the wireless communication system 10 of FIG. 1, according to various embodiments of the present disclosure.

In the example of FIG. 2, the communication device 100 sends the first symbol of the message to the second communication device 150 (at operation 202). The communication device 100 waits until the corresponding response symbol is received back from the second communication device 150 (at operation 204).

It is possible, due to noise, that the communication device 100 might not hear the correct symbol. The communication device 100 is to persist in sending the symbol until the communication device 100 hears the correct response. When multiple recipients are being addressed, the response must be received from all addressed recipients before cutting the transmission short and proceeding to the next symbol. After some amount of time, when the correct response is not received from all addressed recipients, the communication device 100 should proceed in the blind at the default baud rate.

When the corresponding symbol is sent back from all of the one or more addressed recipients to the communication device 100, the communication device 100 may advance to the next symbol in the message. Otherwise, the communication device 100 must wait until the default bit rate timing dictates that the communication device 100 may move on to the next symbol.

When the last symbol in the message is reached, the communication device 100 ceases transmission. Alternatively, when the optional message boundary symbol is available, the communication device 100 may send the message boundary symbol, allow the message boundary symbol to echo back to the communication device 100, and then the communication device 100 ceases transmission.

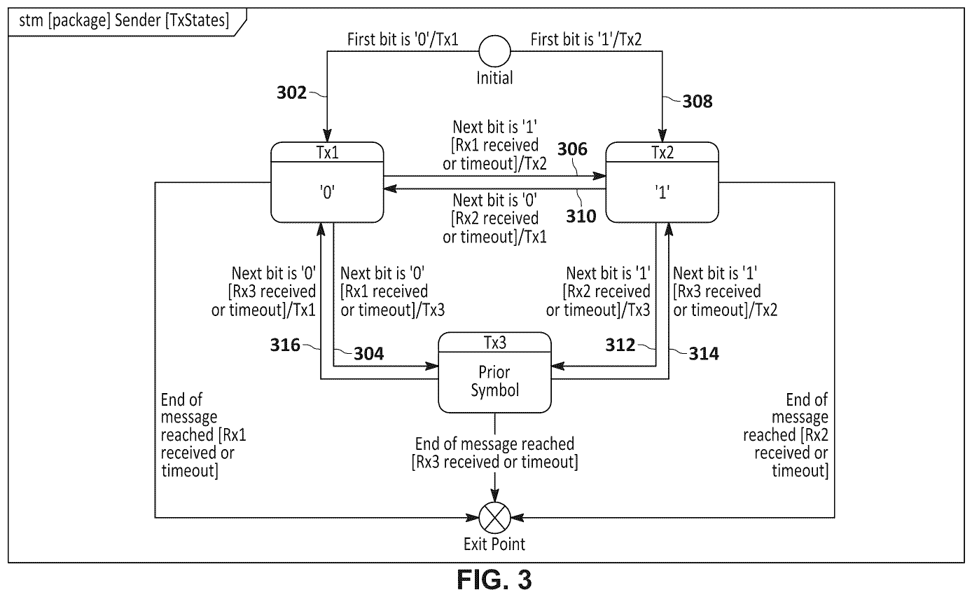

FIG. 3 is a flowchart illustrating a state machine 300 of the communication device 100 in the wireless communication system of FIG. 1, according to various embodiments of the present disclosure. The symbol constellation described in FIG. 3 may vary according to the ability of the hardware and the design choices made in the PHY layer design.

When the first symbol is a “0” (operation 302), the communication device 100 transmits tone TX1 and holds the tone until that tone is either acknowledged by receipt of (the corresponding) tone RX1 or a timeout is reached. The communication device 100 may then move on to the next symbol or cease transmission.

When the second bit in the message is also a zero (operation 304), the communication device 100 transmits and tone TX3. The communication device 100 holds this tone until acknowledged by receipt of (the corresponding) tone RX3 or a timeout is reached. The communication device 100 may then move on to the next symbol or cease transmission.

After receiving the tone RX3, when a next bit in the message is a “1” (operation 314), the communication device 100 transitions to a state in which the communication device 100 transmits and holds tone TX2. The communication device 100 holds this tone until acknowledged by receipt of (the corresponding) tone RX2 or a timeout is reached. The communication device 100 may then move on to the next symbol or cease transmission.

After receiving the tone RX3, when a next bit in the message is a “0” (operation 316), the communication device 100 transitions to a state in which the communication device 100 transmits and holds tone TX1. The communication device 100 holds this tone until acknowledged by receipt of (the corresponding) tone RX1 or a timeout is reached. The communication device 100 may then move on to the next symbol or cease transmission.

When the second bit in the message is a “1” (operation 306), the communication device 100 transitions to a state in which the communication device 100 transmits and holds tone TX2. The communication device 100 holds this tone until acknowledged by receipt of (the corresponding) tone RX2 or a timeout is reached. The communication device 100 may then move on to the next symbol or cease transmission.

When the first symbol is a “1” (operation 308), the communication device 100 transmits tone TX2 and holds the tone until that tone is acknowledged by receipt of (the corresponding) tone RX2 or a timeout is reached. The communication device 100 may then move on to the next symbol or cease transmission.

When the second bit in the message is also a zero (operation 310), the communication device 100 transmits and holds tone TX1. The communication device 100 holds this tone until acknowledged by receipt of (the corresponding) tone RX1 or a timeout is reached. The communication device 100 may then move on to the next symbol or cease transmission.

When the second bit in the message is a “1” (operation 312), the communication device 100 transitions to a state in which the communication device 100 transmits and holds tone TX3. The communication device 100 holds this tone until acknowledged by receipt of (the corresponding) tone RX3 or a timeout is reached. The communication device 100 may then move on to the next symbol or cease transmission.

After receiving the tone RX3, when a next bit in the message is a “1” (operation 314), the communication device 100 transitions to a state in which the communication device 100 transmits and holds tone TX2. The communication device 100 holds this tone until acknowledged by receipt of (the corresponding) tone RX2 or a timeout is reached. The communication device 100 may then move on to the next symbol or cease transmission.

After receiving the tone RX3, when a next bit in the message is a “0” (operation 316), the communication device 100 transitions to a state in which the communication device 100 transmits and holds tone TX1. The communication device 100 holds this tone until acknowledged by receipt of (the corresponding) tone RX1 or a timeout is reached. The communication device 100 may then move on to the next symbol or cease transmission.

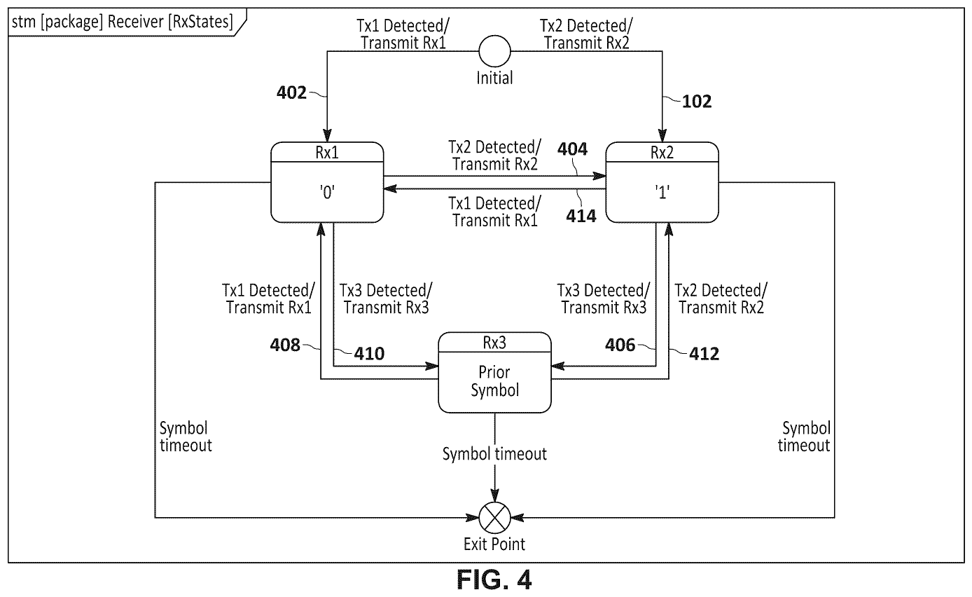

FIG. 4 is a flowchart illustrating a state machine 400 of the second communication device 150 in the wireless communication system of FIG. 1, according to various embodiments of the present disclosure. The symbol constellation described in FIG. 4 may vary according to the ability of the hardware and the design choices made in the PHY layer design.

When the transmission “TX1” is received and detected, (operation 402), the second communication device 150 transmits tone RX1 and holds the tone until that tone is either acknowledged by detection of another transmission or a timeout is reached. The second communication device 150 may then move on to the next symbol or determine a symbol timeout.

After transmitting the tone RX1, when the next transmission “TX2” is received and detected (operation 404), the second communication device 150 transmits tone RX2 and holds the tone until that tone is either acknowledged by detection of another transmission or a timeout is reached. The second communication device 150 may then move on to the next symbol or determine a symbol timeout.

After transmitting the tone RX2, when the next transmission “TX3” is received and detected (operation 406), the second communication device 150 transmits tone RX3 and holds the tone until that tone is either acknowledged by detection of another transmission or a timeout is reached. The second communication device 150 may then move on to the next symbol or determine a symbol timeout.

After transmitting the tone RX3, when the next transmission “TX1” is received and detected (operation 408), the second communication device 150 transmits tone RX1 and holds the tone until that tone is either acknowledged by detection of another transmission or a timeout is reached. The second communication device 150 may then move on to the next symbol or determine a symbol timeout.

After transmitting the tone RX1, when the next transmission “TX3” is received and detected (operation 410), the second communication device 150 transmits tone RX3 and holds the tone until that tone is either acknowledged by detection of another transmission or a timeout is reached. The second communication device 150 may then move on to the next symbol or determine a symbol timeout.

After transmitting the tone RX3, when the next transmission “TX2” is received and detected (operation 412), the second communication device 150 transmits tone RX2 and holds the tone until that tone is either acknowledged by detection of another transmission or a timeout is reached. The second communication device 150 may then move on to the next symbol or determine a symbol timeout.

After transmitting the tone RX2, when the next transmission “TX1” is received and detected (operation 414), the second communication device 150 transmits tone RX1 and holds the tone until that tone is either acknowledged by detection of another transmission or a timeout is reached. The second communication device 150 may then move on to the next symbol or determine a symbol timeout.

As illustrated in FIG. 4, the second communication device 150 listens for each symbol tone. When a sufficient number of samples have been gathered to confirm the frequency, the second communication device 150 acknowledges the symbol by transmitting the corresponding acknowledgement symbol.

The second communication device 150 also continues transmitting the acknowledgement symbol while a new symbol is received. When a sufficient number of samples have been gathered to confirm the new symbol, the second communication device 150 acknowledges the new symbol by transmitting the corresponding acknowledgement symbol. When there is no subsequent symbol, the second communication device 150 determines a symbol timeout by ceasing transmission of the acknowledgement symbol and terminates the message.

As illustrated in FIGS. 3 and 4, the second communication device 150 will echo back a symbol corresponding to the symbol received by the second communication device 150. The communication device 100 will maintain the symbol the communication device 100 is sending until gets the correct report back. When the communication device 100 believes the second communication device 150 has reported the wrong symbol, the communication device 100 will maintain the current symbol.

The communication device 100 need only dwell as long as the link budget requires for the symbol to be delivered. The communication device 100 also cannot freely slide between tones while transmitting without a few ground rules in place.

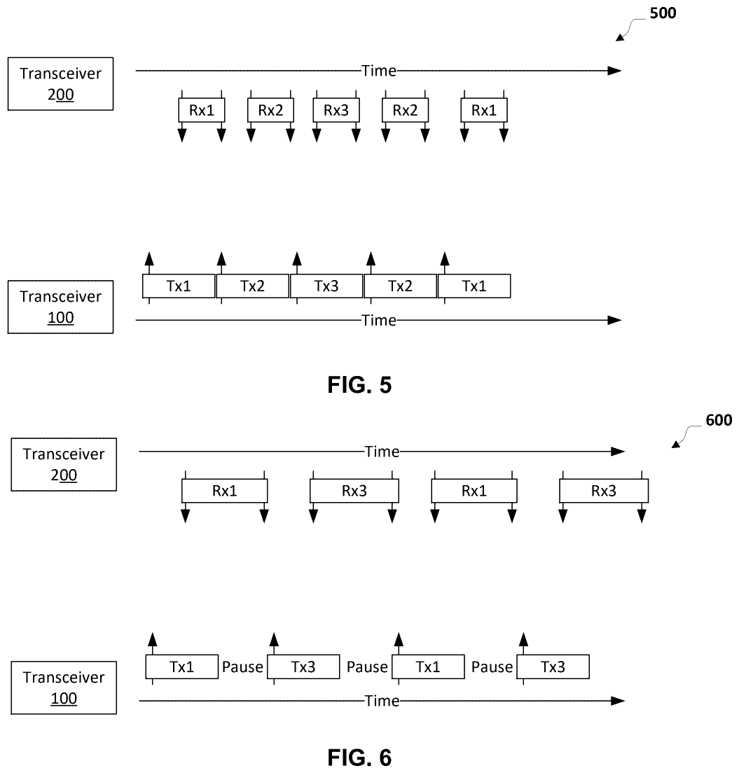

FIG. 5 is a diagram illustrating a first example 500 of transmission and reception tones of the communication device 100 and the second communication device 150 in the wireless communication system of FIG. 1, according to various embodiments of the present disclosure.

As illustrated in FIG. 5, the basic concept is that the communication device 100 issues symbol tones (e.g., Tx1, Tx2, and Tx3) only to be answered by the corresponding symbol tones by the second communication device 150 (e.g., Rx1, Rx2, and Rx3, respectively).

However, a pitfall arises in the example 500 when the communication device 100 attempts to send symbol tones which have another symbol tone between them. For the communication device 100 to transition the transmission between Tx1 and Tx3, the communication device 100 must run through the tone used to represent Tx2. This cannot be allowed because this “transition” or “slurring” could cause the second communication device 150 to inadvertently identify Tx2 during the transition from Tx1 to Tx3.

FIG. 6 is a diagram illustrating a second example 600 of transmission and reception symbols of the communication device 100 and the second communication device 150 in the wireless communication system of FIG. 1, according to various embodiments of the present disclosure.

As illustrated in FIG. 6, one remedy to the “slurring” would be to take the approach where the communication device 100 is transitioning to a symbol that requires the communication device 100 to pass through another symbol, the communication device 100 must go quiet (pause) in the process of transitioning to that symbol.

The pause between transmissions by the communication device 100 could be as long as it takes for the transmission to travel from the second communication device 150 to the communication device 100. However, it need only be as long as it takes for the PLL of the second communication device 150 to identify that it has lost synchronization. In some examples, the silence must be for some arbitrary number (e.g., 25 cycles). This would correspond to 55 nanoseconds (ns). The new symbol by the communication device 100 must then appear at the correct frequency without sliding from the old one to the new one.

A circuit could be used to silence the power amplifier of the communication device 100 during the time of silence.

However, there is likely a slight speed advantage to the system when pauses are not used during the transmission, while neighboring symbols are sent.

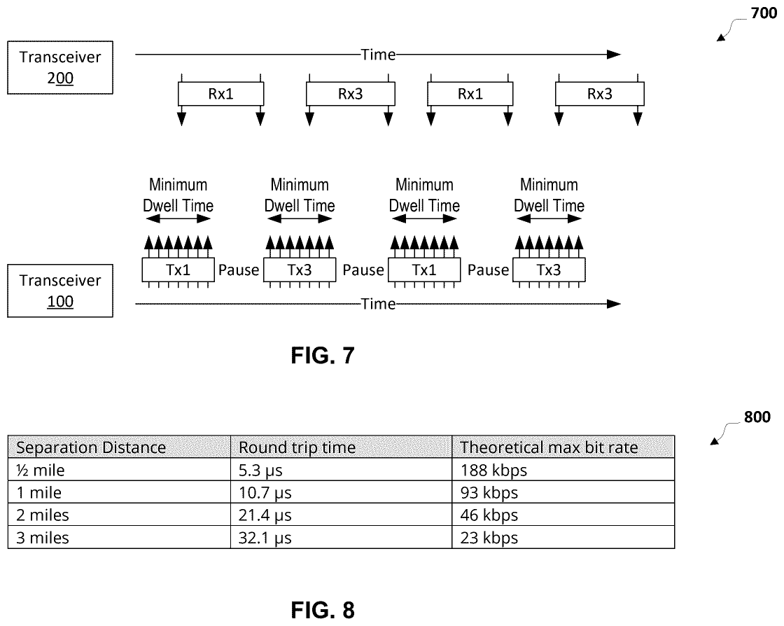

FIG. 7 is a diagram illustrating a third example 700 of transmission and reception symbols of the communication device 100 and the second communication device 150 in the wireless communication system of FIG. 1, according to various embodiments of the present disclosure.

In FIG. 7, the communication devices 100 and 150 must obey one of several behaviors in order to communicate successfully. First, the communication device 100 must transition from symbol to symbol quickly. A minimum dwell time can be prearranged between the communication device 100 and the second communication device 150. Until a symbol tone meets the minimum dwell time, the symbol is not considered to be transmitted. By default, this minimum dwell time is one cycle at the symbol being transmitted.

Alternatively, symbols may be sent with interruptions between them. The communication device 100 must only send symbol tones at the appropriate frequencies. Additionally, the movement between symbol tones should be parameterized (much like baud rates are parameterized with the legacy systems.)

The speed of light can cover distance quickly, but not instantly. When the second communication device 150 is one mile away from the communication device 100, then the roundtrip signal must travel two miles through space. At 186 kmi/s, light 10.7 microseconds (μs) to travel the two mile roundtrip. At 450 megahertz (MHz), that is enough space to store 450 M cycles/sec/(186000 mi/sec/2 mi), which equals 4838 cycles. At 450 MHz, each cycle of the symbol requires 2.2 ns (i.e., a minimum dwell time) to be considered transmitted. When the second communication device 150 identifies the symbol in 20 cycles, then only 44 ns are spent in the actual signal lock for the symbol.

Communication rates will vary as a function of distance. This implies that the network should be designed with numerous, low power, full duplex transmitters, positioned near the second communication device 150.

FIG. 8 is a table illustrating communication rates 800 of the wireless communication system of FIG. 1, according to various embodiments of the present disclosure. When the separation distance of the communication device 100 and 150 is half a mile, the roundtrip time is 5.3 μs and the theoretical max bit rate is 188 kilobytes per second (kbps). When the separation distance of the communication device 100 and 150 is a mile, the roundtrip time is 10.7 μs and the theoretical max bit rate is 93 kbps. When the separation distance of the communication device 100 and 150 is a mile and a half, the roundtrip time is 21.4 μs and the theoretical max bit rate is 46 kbps. When the separation distance of the communication device 100 and 150 is two miles, the roundtrip time is 32.1 microseconds (μs), and the theoretical max bit rate is 23 kbps.

In some examples, the communication device 100 and/or the second communication device 150 may also support “sidelink” communication to another communication device. When a given communication device's uplink has failed, and the sidelink is then used as an uplink alternative, the need for bandwidth along the sidelink could be quite high in order to move data to and from the CNG. All communication devices have full duplex capability.

A Distributed Coordinator is essentially a repeater. This will likely require full-duplex capability given the need for frequent control traffic. The protocol might find a use between the Distributed Coordinator and one or more of the communication devices.

The use case for distribution automation is to extend the utility's SCADA system beyond the yard and into the field. Anything less than full Ethernet performance (as enjoyed in the substation yard) requires some salesmanship in order to sell it to the customer. A high-performance Edge Gateway might be developed that is full duplex and uses the proposed protocol.

The bitwise reporting protocol of the present disclosure may be beneficially used in fiber optic communication, fifth generation (5G) telecommunication, or other suitable communication medium. The bitwise reporting protocol, when outfitted on endpoints, could (at possibly lower speed) reach endpoints that are suffering from fringe reception. The bitwise reporting protocol, when outfitted on endpoints, could also provide an enormous, system-wide, improvement in bandwidth.

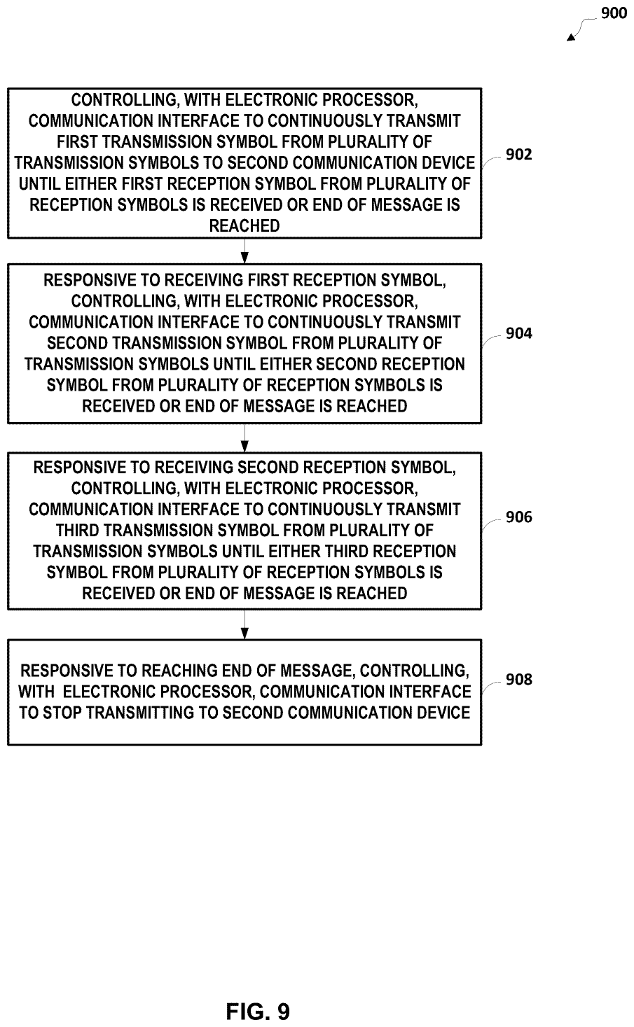

FIG. 9 is a flowchart illustrating a method 900 for operating a communication device with a bitwise reporting protocol, according to various embodiments of the present disclosure. For ease of understanding, the method 900 is described with respect to the communication device 100 of the wireless communication system 10 of FIG. 1. However, the method 900 is equally applicable to the communication device 150 of FIG. 1 or any other additional communication device of the wireless communication system 10.

The method 900 includes controlling, with an electronic processor, a communication interface to continuously transmit a first transmission symbol from a plurality of transmission symbols to a second communication device until either a first reception symbol from a plurality of reception symbols is received or an end of message is reached (at block 902).

The method 900 includes responsive to receiving the first reception symbol, controlling, with the electronic processor, the communication interface to continuously transmit a second transmission symbol from the plurality of transmission symbols until either a second reception symbol from the plurality of reception symbols is received or the end of message is reached (at block 904).

The method 900 includes responsive to receiving the second reception symbol, controlling, with the electronic processor, the communication interface to continuously transmit a third transmission symbol from the plurality of transmission symbols until either a third reception symbol from the plurality of reception symbols is received or the end of message is reached (at block 906).

The method 900 also includes responsive to reaching the end of message, controlling, with the electronic processor, the communication interface to stop transmitting to the second communication device (at block 908).

In some examples, the first transmission symbol indicates a “0”, wherein the second transmission symbol indicates a “1”, and wherein the third transmission symbol indicates a previous symbol.

In some examples, the method 900 may further include controlling the communication interface to insert a first predetermined break in transmission upon changing from transmitting the first transmission symbol to transmitting the second transmission symbol, controlling the communication interface to insert a second predetermined break in transmission upon changing from transmitting the first transmission symbol to transmitting the third transmission symbol, controlling the communication interface to insert a third predetermined break in transmission upon changing from transmitting the second transmission symbol to transmitting the first transmission symbol, controlling the communication interface to insert a fourth predetermined break in transmission upon changing from transmitting the second transmission symbol to transmitting the third transmission symbol, controlling the communication interface to insert a fifth predetermined break in transmission upon changing from transmitting the third transmission symbol to transmitting the second transmission symbol, and controlling the communication interface to insert a sixth predetermined break in transmission upon changing from transmitting the third transmission symbol to transmitting the first transmission symbol.

In some examples, the method 900 may further include controlling the communication interface to continuously transmit the second transmission symbol from the plurality of transmission symbols until either the second reception symbol from the plurality of reception symbols is received or the end of message is reached, responsive to receiving the second reception symbol, controlling the communication interface to continuously transmit the first transmission symbol from the plurality of transmission symbols until either the first reception symbol from the plurality of reception symbols is received or the end of message is reached, and responsive to receiving the first reception symbol, controlling the communication interface to continuously transmit the third transmission symbol from the plurality of transmission symbols until either the third reception symbol from the plurality of reception symbols is received or the end of message is reached.

In some examples, the method 900 may further include controlling the communication interface to continuously transmit the second transmission symbol from the plurality of transmission symbols until either the second reception symbol from the plurality of reception symbols is received or the end of message is reached, responsive to receiving the second reception symbol, controlling the communication interface to continuously transmit the third transmission symbol from the plurality of transmission symbols until either the third reception symbol from the plurality of reception symbols is received or the end of message is reached, and responsive to receiving the third reception symbol, controlling the communication interface to continuously transmit the first transmission symbol from the plurality of transmission symbols until either the first reception symbol from the plurality of reception symbols is received or the end of message is reached.

In some examples, the method 900 may further include controlling the communication interface to continuously transmit the first transmission symbol from the plurality of transmission symbols until either the first reception symbol from the plurality of reception symbols is received or the end of message is reached, responsive to receiving the first reception symbol, controlling the communication interface to continuously transmit the third transmission symbol from the plurality of transmission symbols until either the third reception symbol from the plurality of reception symbols is received or the end of message is reached, and responsive to receiving the third reception symbol, controlling the communication interface to continuously transmit the second transmission symbol from the plurality of transmission symbols until either the second reception symbol from the plurality of reception symbols is received or the end of message is reached.

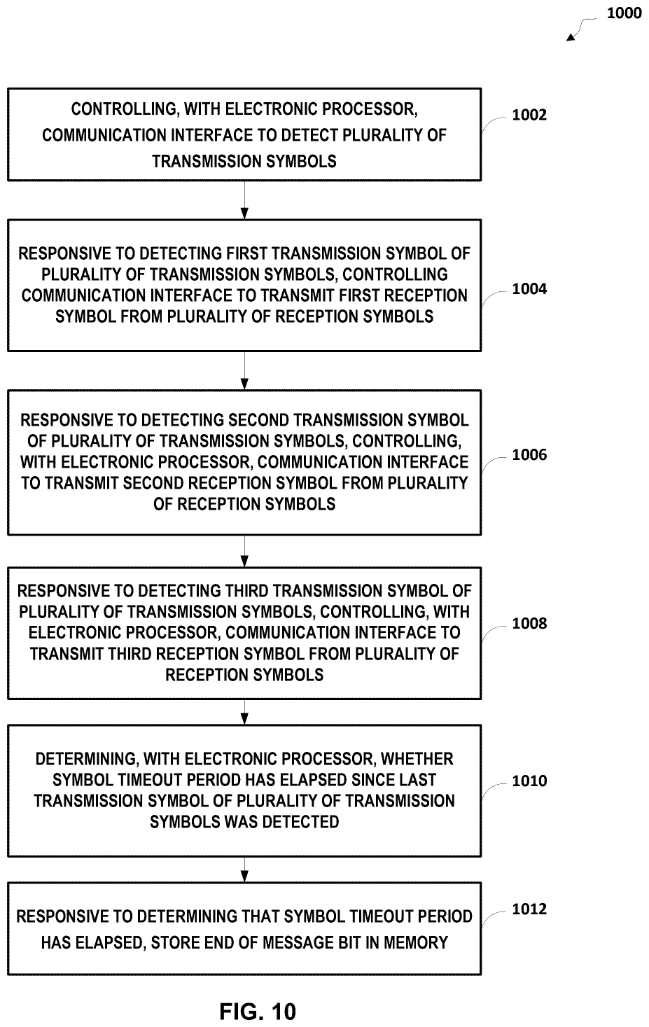

FIG. 10 is a flowchart illustrating a second method 1000 for operating a communication device with a bitwise reporting protocol, according to various embodiments of the present disclosure. For ease of understanding, the method 1000 is described with respect to the communication device 150 of the wireless communication system 10 of FIG. 1. However, the method 1000 is equally applicable to the communication device 100 of FIG. 1 or any other additional communication device of the wireless communication system 10.

The method 1000 includes controlling, with an electronic processor, a communication interface to detect a plurality of transmission symbols (at block 1002).

The method 1000 includes responsive to detecting a first transmission symbol of the plurality of transmission symbols, controlling the communication interface to transmit a first reception symbol from a plurality of reception symbols (at block 1004).

The method 1000 includes responsive to detecting a second transmission symbol of the plurality of transmission symbols, controlling, with the electronic processor, the communication interface to transmit a second reception symbol from the plurality of reception symbols (at block 1006).

The method 1000 includes responsive to detecting a third transmission symbol of the plurality of transmission symbols, controlling, with the electronic processor, the communication interface to transmit a third reception symbol from the plurality of reception symbols (at block 1008).

The method 1000 includes determining, with the electronic processor, whether a symbol timeout period has elapsed since a last transmission symbol of the plurality of transmission symbols was detected (at block 1010).

The method 1000 also includes responsive to determining that the symbol timeout period has elapsed, store an end of message bit in a memory (at block 1012).

In some examples, the first transmission symbol indicates a “0”, wherein the second transmission symbol indicates a “1”, and wherein the third transmission symbol indicates a previous symbol.

In some examples, the method 1000 may further include responsive to detecting the second transmission symbol of the plurality of transmission symbols, controlling, with the electronic processor, the communication interface to transmit the second reception symbol from the plurality of reception symbols, responsive to detecting the first transmission symbol of the plurality of transmission symbols, controlling the communication interface to transmit the first reception symbol from the plurality of reception symbols, and responsive to detecting the third transmission symbol of the plurality of transmission symbols, controlling, with the electronic processor, the communication interface to transmit the third reception symbol from the plurality of reception symbols.

In some examples, the method 1000 may further include responsive to detecting the second transmission symbol of the plurality of transmission symbols, controlling, with the electronic processor, the communication interface to transmit the second reception symbol from the plurality of reception symbols, responsive to detecting the third transmission symbol of the plurality of transmission symbols, controlling, with the electronic processor, the communication interface to transmit the third reception symbol from the plurality of reception symbols, and responsive to detecting the first transmission symbol of the plurality of transmission symbols, controlling the communication interface to transmit the first reception symbol from the plurality of reception symbols.

In some examples, the method 1000 may further include responsive to detecting the

first transmission symbol of the plurality of transmission symbols, controlling the communication interface to transmit the first reception symbol from the plurality of reception symbols, responsive to detecting the third transmission symbol of the plurality of transmission symbols, controlling, with the electronic processor, the communication interface to transmit the third reception symbol from the plurality of reception symbols, and responsive to detecting the second transmission symbol of the plurality of transmission symbols, controlling, with the electronic processor, the communication interface to transmit the second reception symbol from the plurality of reception symbols.

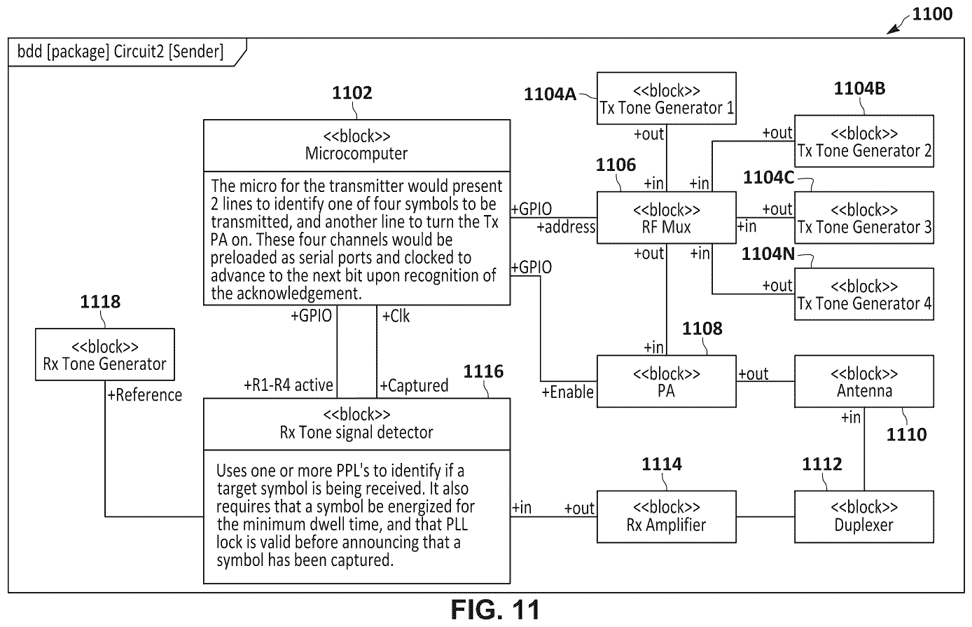

FIG. 11 is a block diagram illustrating an example 1100 of a first communication device 100 of the wireless communication system 10 of FIG. 1, according to various embodiments of the present disclosure. In FIG. 11, the example 1100 includes a microcomputer 1102, a plurality of transmission tone generators 1104A-1104N, a radio frequency multiplexer 1106, a power amplifier 1108, an antenna 1110, a duplexer 1112, a receiver amplifier 1114, a reception tone signal detector 1116, and a reception tone generator 1118.

The microcomputer 1102 corresponds to the electronic processor 102 and the memory 104 in the communication device 100 of FIG. 1. The plurality of transmission tone generators 1104A-1104N, the radio frequency multiplexer 1106, the power amplifier 1108, the antenna 1110, the duplexer 1112, the receiver amplifier 1114, the reception tone signal detector 1116, and the reception tone generator 1118 correspond to the communication interface 112 in the communication device 100 of FIG. 1.

The microcomputer 1102 presents two lines to identify one of four symbols to be transmitted, and another line to turn on the transmitter power amplifier 1108. These four channels would be preloaded as serial ports and clocked to advance to the next bit upon recognition of the acknowledgement.

Each of the plurality of transmission tone generators 1104A-1104N generates a transmission symbol tone. The radio frequency multiplexer 1106 multiplexes the transmission symbol tones generated by the plurality of transmission tone generators 1104A-1104N. The power amplifier 1108 receives the multiplexed signal output from the radio frequency multiplexer 1106 and amplifies the multiplexed signal. The antenna 1110 receives and transmits the amplified multiplexed signal.

The duplexer 1112 separates a received signal from the transmitted signal. The receiver amplifier 1114 amplifies the received signal. The reception tone signal detector 1116 detects whether a reception symbol tone that corresponds to the transmission symbol tone has been received. The reception tone generator 1118 provides a reference signal with the expected reception symbol tone.

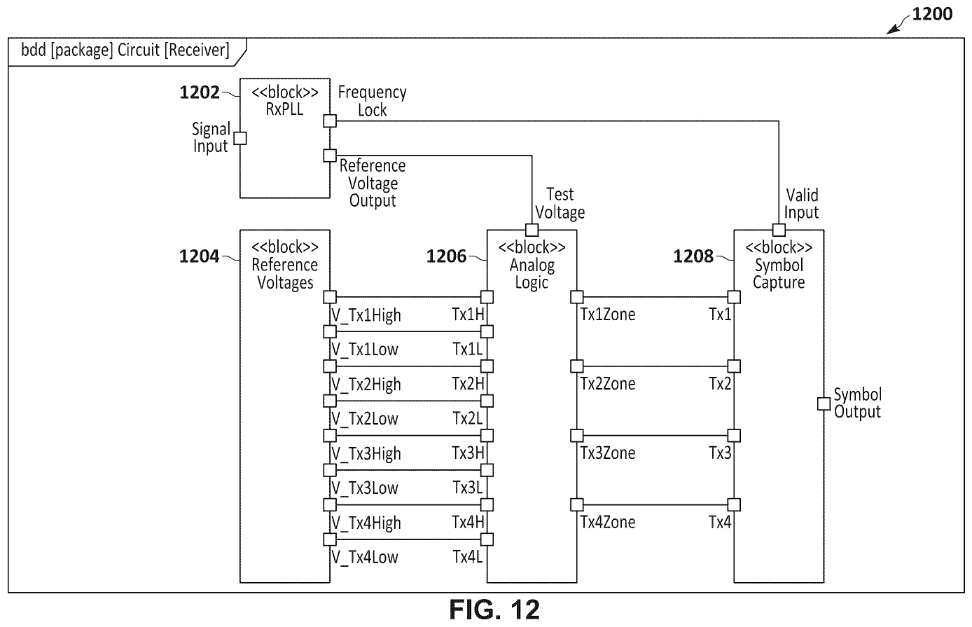

FIG. 12 is a block diagram illustrating an example 1200 of a second communication device 150 of the wireless communication system 10 of FIG. 1, according to various embodiments of the present disclosure. In FIG. 12, the example 1200 includes a reception phase lock loop 1202, reference voltages block 1204, an analogic logic block 1206, and a symbol capture block 1208.

The reception phase lock loop 1202 corresponds to the communication interface 162 in the communication device 150 of FIG. 1. The reference voltages block 1204, the analog logic block 1206, and the symbol capture block 1208 corresponds to the electronic processor 102 and the memory 154 in the communication device 150 of FIG. 1.

The reception phase lock loop 1202 receives a signal input and a reference voltage output, and provides a frequency lock as a valid input to the symbol capture block 1208. The reference voltages block 1204 provides a plurality of reference voltages to the analog logic block 1206. The analog logic block 1206 outputs a test voltage to the reception phase lock loop 1202 as the reference voltage output. The analog logic block 1206 also outputs transmission symbol zones to the symbol capture block 1208. The symbol capture block 1208 outputs a symbol output based on the transmission symbol zones and the valid input from the reception phase lock loop 1202.

In view of the foregoing, the present disclosure describes a “clockless” protocol. The “clockless” protocol allows the transmitter to synchronize with the receiver and communicate at the fastest rate they can agree to and is negotiated bit by bit-not once up front like the old fashioned modem connection. The “clockless” protocol also maintains the integrity of the communication link because each bit is confirmed as the message is sent.

Specifically, the sender and recipient will have a pre-agreed set of symbols that they use. In a first example, a set of three transmit symbols and three receive symbols may be used to transmit messages broken up into single bits of “0” and “1.” In a second example, a set of five transmit symbols and five corresponding receive symbols may be used to transmit messages broken up into two bits “00,” “01,” “10,” and “11.” In other words, 2³+1=9 symbols would be used in a symbol constellation to represent four bit pairs, where one symbol in the constellation must always be a “previous symbol.” The use of “previous symbol” allows the protocol to be clockless because it is the change in symbols that communicates the new symbol, not the clock running.

Additionally, when the first bit in the message is sent, the first bit is always one representing (one or more) bits. The first bit cannot be the “previous symbol” symbol because there is no previous symbol when it is the first bit.

The following are enumerated examples of the devices, systems, and methods of the present disclosure. Example 1: a communication device comprising: a communication interface including a radio frequency (RF) transceiver, the communication interface configured to wirelessly communicate with a second communication device; a memory; and an electronic processor communicatively connected to the memory and the communication interface, the electronic processor is configured to control the communication interface to continuously transmit a first transmission symbol from a plurality of transmission symbols until either a first reception symbol from a plurality of reception symbols is received or an end of message is reached, responsive to receiving the first reception symbol, control the communication interface to continuously transmit a second transmission symbol from the plurality of transmission symbols until either a second reception symbol from the plurality of reception symbols is received or the end of message is reached, responsive to receiving the second reception symbol, control the communication interface to continuously transmit a third transmission symbol from the plurality of transmission symbols until either a third reception symbol from the plurality of reception symbols is received or the end of message is reached, and responsive to reaching the end of message, control the communication interface to stop transmitting to the second communication device.

Example 2: the communication device of Example 1, wherein the first transmission symbol indicates a “0”, wherein the second transmission symbol indicates a “1”, and wherein the third transmission symbol indicates a previous symbol.

Example 3: the communication device of Examples 1 or 2, wherein the electronic processor is further configured to control the communication interface to insert a first predetermined break in transmission upon changing from transmitting the first transmission symbol to transmitting the second transmission symbol, control the communication interface to insert a second predetermined break in transmission upon changing from transmitting the first transmission symbol to transmitting the third transmission symbol, control the communication interface to insert a third predetermined break in transmission upon changing from transmitting the second transmission symbol to transmitting the first transmission symbol, control the communication interface to insert a fourth predetermined break in transmission upon changing from transmitting the second transmission symbol to transmitting the third transmission symbol, control the communication interface to insert a fifth predetermined break in transmission upon changing from transmitting the third transmission symbol to transmitting the second transmission symbol, and control the communication interface to insert a sixth predetermined break in transmission upon changing from transmitting the third transmission symbol to transmitting the first transmission symbol.

Example 4: the communication device of any of Examples 1-3, wherein the electronic processor is further configured to control the communication interface to continuously transmit the second transmission symbol from the plurality of transmission symbols until either the second reception symbol from the plurality of reception symbols is received or the end of message is reached, responsive to receiving the second reception symbol, control the communication interface to continuously transmit the first transmission symbol from the plurality of transmission symbols until either the first reception symbol from the plurality of reception symbols is received or the end of message is reached, and responsive to receiving the first reception symbol, control the communication interface to continuously transmit the third transmission symbol from the plurality of transmission symbols until either the third reception symbol from the plurality of reception symbols is received or the end of message is reached.

Example 5: the communication device of any of Examples 1-4, wherein the electronic processor is further configured to control the communication interface to continuously transmit the second transmission symbol from the plurality of transmission symbols until either the second reception symbol from the plurality of reception symbols is received or the end of message is reached, responsive to receiving the second reception symbol, control the communication interface to continuously transmit the third transmission symbol from the plurality of transmission symbols until either the third reception symbol from the plurality of reception symbols is received or the end of message is reached, and responsive to receiving the third reception symbol, control the communication interface to continuously transmit the first transmission symbol from the plurality of transmission symbols until either the first reception symbol from the plurality of reception symbols is received or the end of message is reached.

Example 6: the communication device of any of Examples 1-5, wherein the electronic processor is further configured to control the communication interface to continuously transmit the first transmission symbol from the plurality of transmission symbols until either the first reception symbol from the plurality of reception symbols is received or the end of message is reached, responsive to receiving the first reception symbol, control the communication interface to continuously transmit the third transmission symbol from the plurality of transmission symbols until either the third reception symbol from the plurality of reception symbols is received or the end of message is reached, and responsive to receiving the third reception symbol, control the communication interface to continuously transmit the second transmission symbol from the plurality of transmission symbols until either the second reception symbol from the plurality of reception symbols is received or the end of message is reached.

Example 7: a communication method comprising: controlling, with an electronic processor, a communication interface to continuously transmit a first transmission symbol from a plurality of transmission symbols to a second communication device until either a first reception symbol from a plurality of reception symbols is received or an end of message is reached; responsive to receiving the first reception symbol, controlling, with the electronic processor, the communication interface to continuously transmit a second transmission symbol from the plurality of transmission symbols until either a second reception symbol from the plurality of reception symbols is received or the end of message is reached; responsive to receiving the second reception symbol, controlling, with the electronic processor, the communication interface to continuously transmit a third transmission symbol from the plurality of transmission symbols until either a third reception symbol from the plurality of reception symbols is received or the end of message is reached; and responsive to reaching the end of message, controlling, with the electronic processor, the communication interface to stop transmitting to the second communication device.

Example 8: the communication method of Example 7, wherein the first transmission symbol indicates a “0”, wherein the second transmission symbol indicates a “1”, and wherein the third transmission symbol indicates a previous symbol.

Example 9: the communication method of Examples 7 or 8, further comprising: controlling the communication interface to insert a first predetermined break in transmission upon changing from transmitting the first transmission symbol to transmitting the second transmission symbol; controlling the communication interface to insert a second predetermined break in transmission upon changing from transmitting the first transmission symbol to transmitting the third transmission symbol; controlling the communication interface to insert a third predetermined break in transmission upon changing from transmitting the second transmission symbol to transmitting the first transmission symbol; controlling the communication interface to insert a fourth predetermined break in transmission upon changing from transmitting the second transmission symbol to transmitting the third transmission symbol; controlling the communication interface to insert a fifth predetermined break in transmission upon changing from transmitting the third transmission symbol to transmitting the second transmission symbol; and controlling the communication interface to insert a sixth predetermined break in transmission upon changing from transmitting the third transmission symbol to transmitting the first transmission symbol.

Example 10: the communication method of any of Examples 7-9, further comprising: controlling the communication interface to continuously transmit the second transmission symbol from the plurality of transmission symbols until either the second reception symbol from the plurality of reception symbols is received or the end of message is reached; responsive to receiving the second reception symbol, controlling the communication interface to continuously transmit the first transmission symbol from the plurality of transmission symbols until either the first reception symbol from the plurality of reception symbols is received or the end of message is reached; and responsive to receiving the first reception symbol, controlling the communication interface to continuously transmit the third transmission symbol from the plurality of transmission symbols until either the third reception symbol from the plurality of reception symbols is received or the end of message is reached.

Example 11: the communication method of any of Examples 7-10, further comprising: controlling the communication interface to continuously transmit the second transmission symbol from the plurality of transmission symbols until either the second reception symbol from the plurality of reception symbols is received or the end of message is reached; responsive to receiving the second reception symbol, controlling the communication interface to continuously transmit the third transmission symbol from the plurality of transmission symbols until either the third reception symbol from the plurality of reception symbols is received or the end of message is reached; and responsive to receiving the third reception symbol, controlling the communication interface to continuously transmit the first transmission symbol from the plurality of transmission symbols until either the first reception symbol from the plurality of reception symbols is received or the end of message is reached.

Example 12: the communication method of any of Examples 7-11, further comprising: controlling the communication interface to continuously transmit the first transmission symbol from the plurality of transmission symbols until either the first reception symbol from the plurality of reception symbols is received or the end of message is reached; responsive to receiving the first reception symbol, controlling the communication interface to continuously transmit the third transmission symbol from the plurality of transmission symbols until either the third reception symbol from the plurality of reception symbols is received or the end of message is reached; and responsive to receiving the third reception symbol, controlling the communication interface to continuously transmit the second transmission symbol from the plurality of transmission symbols until either the second reception symbol from the plurality of reception symbols is received or the end of message is reached.

Example 13: a communication device comprising: a communication interface including a radio frequency (RF) transceiver, the communication interface configured to wirelessly communicate with a second communication device; a memory; and an electronic processor communicatively connected to the memory and the communication interface, the electronic processor is configured to control the communication interface to detect a plurality of transmission symbols, responsive to detecting a first transmission symbol of the plurality of transmission symbols, control the communication interface to transmit a first reception symbol from a plurality of reception symbols, responsive to detecting a second transmission symbol of the plurality of transmission symbols, control the communication interface to transmit a second reception symbol from the plurality of reception symbols, responsive to detecting a third transmission symbol of the plurality of transmission symbols, control the communication interface to transmit a third reception symbol from the plurality of reception symbols, determine whether a symbol timeout period has elapsed since a last transmission symbol of the plurality of transmission symbols was detected, and responsive to determining that the symbol timeout period has elapsed, store an end of message bit in the memory.

Example 14: the communication device of Example 13, wherein the first transmission symbol indicates a “0”, wherein the second transmission symbol indicates a “1”, and wherein the third transmission symbol indicates a previous symbol.

Example 15: a communication method comprising: controlling, with an electronic processor, a communication interface to detect a plurality of transmission symbols; responsive to detecting a first transmission symbol of the plurality of transmission symbols, controlling the communication interface to transmit a first reception symbol from a plurality of reception symbols; responsive to detecting a second transmission symbol of the plurality of transmission symbols, controlling, with the electronic processor, the communication interface to transmit a second reception symbol from the plurality of reception symbols; responsive to detecting a third transmission symbol of the plurality of transmission symbols, controlling, with the electronic processor, the communication interface to transmit a third reception symbol from the plurality of reception symbols; determining, with the electronic processor, whether a symbol timeout period has elapsed since a last transmission symbol of the plurality of transmission symbols was detected, and responsive to determining that the symbol timeout period has elapsed, store an end of message bit in a memory.

Example 16: the communication method of Example 15, wherein the first transmission symbol indicates a “0”, wherein the second transmission symbol indicates a “1”,and wherein the third transmission symbol indicates a previous symbol.

Example 17: the communication method of Examples 15 or 16, further comprising: responsive to detecting the second transmission symbol of the plurality of transmission symbols, controlling, with the electronic processor, the communication interface to transmit the second reception symbol from the plurality of reception symbols; responsive to detecting the first transmission symbol of the plurality of transmission symbols, controlling the communication interface to transmit the first reception symbol from the plurality of reception symbols; and responsive to detecting the third transmission symbol of the plurality of transmission symbols, controlling, with the electronic processor, the communication interface to transmit the third reception symbol from the plurality of reception symbols.

Example 18: the communication method of any of Examples 15-17, further comprising: responsive to detecting the second transmission symbol of the plurality of transmission symbols, controlling, with the electronic processor, the communication interface to transmit the second reception symbol from the plurality of reception symbols; responsive to detecting the third transmission symbol of the plurality of transmission symbols, controlling, with the electronic processor, the communication interface to transmit the third reception symbol from the plurality of reception symbols; and responsive to detecting the first transmission symbol of the plurality of transmission symbols, controlling the communication interface to transmit the first reception symbol from the plurality of reception symbols.

Example 19: the communication method of any of Examples 15-18, further comprising: responsive to detecting the first transmission symbol of the plurality of transmission symbols, controlling the communication interface to transmit the first reception symbol from the plurality of reception symbols; responsive to detecting the third transmission symbol of the plurality of transmission symbols, controlling, with the electronic processor, the communication interface to transmit the third reception symbol from the plurality of reception symbols; and responsive to detecting the second transmission symbol of the plurality of transmission symbols, controlling, with the electronic processor, the communication interface to transmit the second reception symbol from the plurality of reception symbols.

In the foregoing specification, specific embodiments, examples, aspects, and features have been described. However, one of ordinary skill in the art appreciates that various modifications and changes can be made without departing from the scope of the subject matter as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Unless indicated otherwise, or technically precluded, the aspects described in this application can be used individually or in combination. Various numeric values are used in the present application. The specific values are for example purposes and the aspects described are not limited to these specific values.

Moreover, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if embodiments described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some embodiments, examples, aspects, and features may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, one or more of the embodiments, examples, aspects, and features presented herein can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object-oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information may include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations, for example, storing the information, processing the information, transmitting the information, moving the information, copying the information, erasing the information, calculating the information, determining the information, predicting the information, or estimating the information.

As will be evident to one of ordinary skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of,” without a more limiting modifier such as “only one of,” and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled,” “coupling,” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples and embodiments for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed embodiment. Therefore, the following claims are hereby incorporated into the Detailed Description, with each claim standing on its own as a separately claimed subject matter.

Thus, the present disclosure provides, among other things, devices, systems, and methods including radio frequency communication with a bitwise reporting protocol. Various features and advantages of the present disclosure are set forth in the following claims.

What is claimed is:

1. A communication device comprising:
a communication interface including a radio frequency (RF) transceiver, the communication interface configured to wirelessly communicate with a second communication device;
a memory; and
an electronic processor communicatively connected to the memory and the communication interface, the electronic processor is configured to
control the communication interface to continuously transmit a first transmission symbol from a plurality of transmission symbols until either a first reception symbol from a plurality of reception symbols is received or an end of message is reached,
responsive to receiving the first reception symbol, control the communication interface to continuously transmit a second transmission symbol from the plurality of transmission symbols until either a second reception symbol from the plurality of reception symbols is received or the end of message is reached,
responsive to receiving the second reception symbol, control the communication interface to continuously transmit a third transmission symbol from the plurality of transmission symbols until either a third reception symbol from the plurality of reception symbols is received or the end of message is reached, and
responsive to reaching the end of message, control the communication interface to stop transmitting to the second communication device.

2. The communication device of claim 1, wherein the first transmission symbol indicates a “0”, wherein the second transmission symbol indicates a “1”, and wherein the third transmission symbol indicates a previous symbol.

3. The communication device of claim 1, wherein the electronic processor is further configured to
control the communication interface to insert a first predetermined break in transmission upon changing from transmitting the first transmission symbol to transmitting the second transmission symbol,
control the communication interface to insert a second predetermined break in transmission upon changing from transmitting the first transmission symbol to transmitting the third transmission symbol,
control the communication interface to insert a third predetermined break in transmission upon changing from transmitting the second transmission symbol to transmitting the first transmission symbol,
control the communication interface to insert a fourth predetermined break in transmission upon changing from transmitting the second transmission symbol to transmitting the third transmission symbol,
control the communication interface to insert a fifth predetermined break in transmission upon changing from transmitting the third transmission symbol to transmitting the second transmission symbol, and
control the communication interface to insert a sixth predetermined break in transmission upon changing from transmitting the third transmission symbol to transmitting the first transmission symbol.

4. The communication device of claim 1, wherein the electronic processor is further configured to
control the communication interface to continuously transmit the second transmission symbol from the plurality of transmission symbols until either the second reception symbol from the plurality of reception symbols is received or the end of message is reached,
responsive to receiving the second reception symbol, control the communication interface to continuously transmit the first transmission symbol from the plurality of transmission symbols until either the first reception symbol from the plurality of reception symbols is received or the end of message is reached, and
responsive to receiving the first reception symbol, control the communication interface to continuously transmit the third transmission symbol from the plurality of transmission symbols until either the third reception symbol from the plurality of reception symbols is received or the end of message is reached.

5. The communication device of claim 1, wherein the electronic processor is further configured to
control the communication interface to continuously transmit the second transmission symbol from the plurality of transmission symbols until either the second reception symbol from the plurality of reception symbols is received or the end of message is reached,
responsive to receiving the second reception symbol, control the communication interface to continuously transmit the third transmission symbol from the plurality of transmission symbols until either the third reception symbol from the plurality of reception symbols is received or the end of message is reached, and
responsive to receiving the third reception symbol, control the communication interface to continuously transmit the first transmission symbol from the plurality of transmission symbols until either the first reception symbol from the plurality of reception symbols is received or the end of message is reached.

6. The communication device of claim 1, wherein the electronic processor is further configured to
control the communication interface to continuously transmit the first transmission symbol from the plurality of transmission symbols until either the first reception symbol from the plurality of reception symbols is received or the end of message is reached,
responsive to receiving the first reception symbol, control the communication interface to continuously transmit the third transmission symbol from the plurality of transmission symbols until either the third reception symbol from the plurality of reception symbols is received or the end of message is reached, and
responsive to receiving the third reception symbol, control the communication interface to continuously transmit the second transmission symbol from the plurality of transmission symbols until either the second reception symbol from the plurality of reception symbols is received or the end of message is reached.

7. A communication method comprising:
controlling, with an electronic processor, a communication interface to continuously transmit a first transmission symbol from a plurality of transmission symbols to a second communication device until either a first reception symbol from a plurality of reception symbols is received or an end of message is reached;
responsive to receiving the first reception symbol, controlling, with the electronic processor, the communication interface to continuously transmit a second transmission symbol from the plurality of transmission symbols until either a second reception symbol from the plurality of reception symbols is received or the end of message is reached;
responsive to receiving the second reception symbol, controlling, with the electronic processor, the communication interface to continuously transmit a third transmission symbol from the plurality of transmission symbols until either a third reception symbol from the plurality of reception symbols is received or the end of message is reached; and
responsive to reaching the end of message, controlling, with the electronic processor, the communication interface to stop transmitting to the second communication device.

8. The communication method of claim 7, wherein the first transmission symbol indicates a “0”, wherein the second transmission symbol indicates a “1”, and wherein the third transmission symbol indicates a previous symbol.

9. The communication method of claim 7, further comprising:
controlling the communication interface to insert a first predetermined break in transmission upon changing from transmitting the first transmission symbol to transmitting the second transmission symbol;
controlling the communication interface to insert a second predetermined break in transmission upon changing from transmitting the first transmission symbol to transmitting the third transmission symbol;
controlling the communication interface to insert a third predetermined break in transmission upon changing from transmitting the second transmission symbol to transmitting the first transmission symbol;
controlling the communication interface to insert a fourth predetermined break in transmission upon changing from transmitting the second transmission symbol to transmitting the third transmission symbol;
controlling the communication interface to insert a fifth predetermined break in transmission upon changing from transmitting the third transmission symbol to transmitting the second transmission symbol; and
controlling the communication interface to insert a sixth predetermined break in transmission upon changing from transmitting the third transmission symbol to transmitting the first transmission symbol.

10. The communication method of claim 7, further comprising:
controlling the communication interface to continuously transmit the second transmission symbol from the plurality of transmission symbols until either the second reception symbol from the plurality of reception symbols is received or the end of message is reached;
responsive to receiving the second reception symbol, controlling the communication interface to continuously transmit the first transmission symbol from the plurality of transmission symbols until either the first reception symbol from the plurality of reception symbols is received or the end of message is reached; and
responsive to receiving the first reception symbol, controlling the communication interface to continuously transmit the third transmission symbol from the plurality of transmission symbols until either the third reception symbol from the plurality of reception symbols is received or the end of message is reached.

11. The communication method of claim 7, further comprising:
controlling the communication interface to continuously transmit the second transmission symbol from the plurality of transmission symbols until either the second reception symbol from the plurality of reception symbols is received or the end of message is reached;
responsive to receiving the second reception symbol, controlling the communication interface to continuously transmit the third transmission symbol from the plurality of transmission symbols until either the third reception symbol from the plurality of reception symbols is received or the end of message is reached; and
responsive to receiving the third reception symbol, controlling the communication interface to continuously transmit the first transmission symbol from the plurality of transmission symbols until either the first reception symbol from the plurality of reception symbols is received or the end of message is reached.

12. The communication method of claim 7, further comprising:
controlling the communication interface to continuously transmit the first transmission symbol from the plurality of transmission symbols until either the first reception symbol from the plurality of reception symbols is received or the end of message is reached;
responsive to receiving the first reception symbol, controlling the communication interface to continuously transmit the third transmission symbol from the plurality of transmission symbols until either the third reception symbol from the plurality of reception symbols is received or the end of message is reached; and
responsive to receiving the third reception symbol, controlling the communication interface to continuously transmit the second transmission symbol from the plurality of transmission symbols until either the second reception symbol from the plurality of reception symbols is received or the end of message is reached.

13. A communication device comprising:
a communication interface including a radio frequency (RF) transceiver, the communication interface configured to wirelessly communicate with a second communication device;
a memory; and
an electronic processor communicatively connected to the memory and the communication interface, the electronic processor is configured to
control the communication interface to detect a plurality of transmission symbols,
responsive to detecting a first transmission symbol of the plurality of transmission symbols, control the communication interface to transmit a first reception symbol from a plurality of reception symbols,
responsive to detecting a second transmission symbol of the plurality of transmission symbols, control the communication interface to transmit a second reception symbol from the plurality of reception symbols,
responsive to detecting a third transmission symbol of the plurality of transmission symbols, control the communication interface to transmit a third reception symbol from the plurality of reception symbols,
determine whether a symbol timeout period has elapsed since a last transmission symbol of the plurality of transmission symbols was detected, and
responsive to determining that the symbol timeout period has elapsed, store an end of message bit in the memory.

14. The communication device of claim 13, wherein the first transmission symbol indicates a “0”, wherein the second transmission symbol indicates a “1”, and wherein the third transmission symbol indicates a previous symbol.

15. A communication method comprising:
controlling, with an electronic processor, a communication interface to detect a plurality of transmission symbols;
responsive to detecting a first transmission symbol of the plurality of transmission symbols, controlling the communication interface to transmit a first reception symbol from a plurality of reception symbols;
responsive to detecting a second transmission symbol of the plurality of transmission symbols, controlling, with the electronic processor, the communication interface to transmit a second reception symbol from the plurality of reception symbols;
responsive to detecting a third transmission symbol of the plurality of transmission symbols, controlling, with the electronic processor, the communication interface to transmit a third reception symbol from the plurality of reception symbols;
determining, with the electronic processor, whether a symbol timeout period has elapsed since a last transmission symbol of the plurality of transmission symbols was detected, and
responsive to determining that the symbol timeout period has elapsed, store an end of message bit in a memory.

16. The communication method of claim 15, wherein the first transmission symbol indicates a “0”, wherein the second transmission symbol indicates a “1”, and wherein the third transmission symbol indicates a previous symbol.

17. The communication method of claim 15, further comprising:
responsive to detecting the second transmission symbol of the plurality of transmission symbols, controlling, with the electronic processor, the communication interface to transmit the second reception symbol from the plurality of reception symbols;
responsive to detecting the first transmission symbol of the plurality of transmission symbols, controlling the communication interface to transmit the first reception symbol from the plurality of reception symbols; and
responsive to detecting the third transmission symbol of the plurality of transmission symbols, controlling, with the electronic processor, the communication interface to transmit the third reception symbol from the plurality of reception symbols.

18. The communication method of claim 15, further comprising:
responsive to detecting the second transmission symbol of the plurality of transmission symbols, controlling, with the electronic processor, the communication interface to transmit the second reception symbol from the plurality of reception symbols;
responsive to detecting the third transmission symbol of the plurality of transmission symbols, controlling, with the electronic processor, the communication interface to transmit the third reception symbol from the plurality of reception symbols; and
responsive to detecting the first transmission symbol of the plurality of transmission symbols, controlling the communication interface to transmit the first reception symbol from the plurality of reception symbols.

19. The communication method of claim 15, further comprising:
responsive to detecting the first transmission symbol of the plurality of transmission symbols, controlling the communication interface to transmit the first reception symbol from the plurality of reception symbols;
responsive to detecting the third transmission symbol of the plurality of transmission symbols, controlling, with the electronic processor, the communication interface to transmit the third reception symbol from the plurality of reception symbols; and
responsive to detecting the second transmission symbol of the plurality of transmission symbols, controlling, with the electronic processor, the communication interface to transmit the second reception symbol from the plurality of reception symbols.
